(19) United States
(12) Patent Application Publication
(10) Pub. No.: US 2023/0078369 A1
(43) Pub. Date: Mar. 16, 2023

(54) IDENTIFICATION SYSTEM, IDENTIFICATION DEVICE, AND IDENTIFICATION METHOD

(71) Applicant: NEC Corporation, Minato-ku, Tokyo (JP)

(72) Inventors: Yukihide YODA, Tokyo (JP); Naoto OGURA, Tokyo (JP); Yoshiaki AONO, Tokyo (JP)

(73) Assignee: NEC Corporation, Minato-ku, Tokyo (JP)

(21) Appl. No.: 17/802,260

(22) PCT Filed: Mar. 25, 2021
(86) PCT No.: PCT/JP2021/012488

§ 371 Date: Aug. 25, 2022

(30) Foreign Application Priority Data
Mar. 26, 2020 (JP) 2020-055613

(51) Int. Cl. G01L 5/105; G01L 1/24; G01N 21/47

(52) U.S. Cl. CPC G01L 5/105; G01L 1/242; G01N 21/474; G01N 2021/4745

(57) ABSTRACT

An identification system (1) includes a transmitter (131) for transmitting pulsed light via an optical fiber (10); a receiver (132) for receiving backscattering light of the pulsed light from the optical fiber (10); a detector (133) for detecting, from the backscattering light, the condition of environment surrounding the optical fiber (10); and an identifier (320) for identifying sagging of the optical fiber (10) from a detection result by the detector (133).

### TECHNICAL FIELD

The present invention relates to an identification system, an identification device, and an identification method that identify hanging down of an optical fiber.

### BACKGROUND ART

PTL 1 discloses a technique for monitoring a state of an optical fiber. The technique described in PTL 1 determines that a fault such as a rupture occurs when detected backscattered light is attenuated.

### CITATION LIST

### Patent Literature

[PTL 1] Japanese Unexamined Patent Application Publication No. 2000-352547

### SUMMARY OF INVENTION

### Technical Problem

However, there is a problem that the technique described in PTL 1 as described above does not identify hanging down of an optical fiber. For example, a drawn portion of an optical fiber being drawn into a house from the outside may hang down due to weight of snow and an influence of a typhoon and the like. When this state is left as it is, the optical fiber hanging down may contact a pedestrian and the like, which may result in an accident. Thus, it is extremely beneficial to provide a technique for identifying hanging down of an optical fiber.

An object of one aspect of the present invention is to achieve an identification system, an identification device, and an identification method that identify hanging down of an optical fiber.

### Solution to Problem

In order to solve the problem described above, an identification system according to one aspect of the present invention includes: a transmission means for transmitting pulse light via an optical fiber; a reception means for receiving backscattered light of the pulse light from the optical fiber; a detection means for detecting an environmental state around the optical fiber from the backscattered light; and an identification means for identifying hanging down of the optical fiber from a detection result of the detection means.

In order to solve the problem described above, an identification device according to one aspect of the present invention includes: an acquisition means for acquiring information indicating backscattered light of pulse light being received from an optical fiber to which the pulse light is transmitted; a detection means for detecting an environmental state around the optical fiber from information indicating the backscattered light; and an identification means for identifying hanging down of the optical fiber from a detection result of the detection means.

In order to solve the problem described above, an identification method according to one aspect of the present invention includes: transmitting pulse light via an optical fiber; receiving backscattered light of the pulse light from the optical fiber; detecting an environmental state around the optical fiber from the backscattered light; and identifying hanging down of the optical fiber from a result of the detection.

### Advantageous Effects of Invention

According to one aspect of the present invention, hanging down of an optical fiber is able to be identified.

### BRIEF DESCRIPTION OF DRAWINGS

FIG. 1 is a diagram illustrating an example of each state of an optical fiber.

FIG. 2 is a diagram illustrating one example of a schematic configuration of an identification system according to a first example embodiment of the present invention.

FIG. 3 is a flowchart illustrating one example of an operation of the identification system according to the first example embodiment of the present invention.

FIG. 4 is a diagram illustrating an example of a time fluctuation in a vibration in a certain position on an optical fiber.

FIG. 5 is a diagram illustrating an example of a spatial distribution of a vibration of an optical fiber at a certain point in time.

FIG. 6 is a diagram illustrating one example of a data structure of information indicating a vibration of an optical fiber.

FIG. 7 is a diagram illustrating a schematic configuration of an identification system according to one modification example of the first example embodiment of the present invention.

FIG. 8 is a diagram illustrating a schematic configuration of an identification system according to another modification example of the first example embodiment of the present invention.

FIG. 9 is a diagram illustrating another example of hanging down of an optical fiber.

FIG. 10 is a flowchart illustrating one example of an operation of an identification system according to a second example embodiment of the present invention.

FIG. 11 is a diagram illustrating an example of a time fluctuation in a temperature of an optical fiber.

FIG. 12 is a diagram illustrating an example of a spatial distribution of a temperature of an optical fiber.

FIG. 13 is a diagram illustrating one example of a schematic configuration of an identification system according to a third example embodiment of the present invention.

FIG. 14 is a flowchart illustrating one example of an operation of the identification system according to the third example embodiment of the present invention.

FIG. 15 is a block diagram illustrating a configuration of an identification system according to a fourth example embodiment.

FIG. 16 is a block diagram illustrating a configuration of an identification device according to a fifth example embodiment.

### EXAMPLE EMBODIMENT

### First Example Embodiment

A first example embodiment according to the present invention will be described below in detail. An identification system according to the first example embodiment identifies hanging down of an optical fiber. Note that, in the present example embodiment, an optical fiber is in a form of being included in an optical line cable outside a communication carrier station building, and “hanging down of an optical fiber” is synonymous with hanging down of an optical line cable.

### (Hanging Down of Optical Fiber)

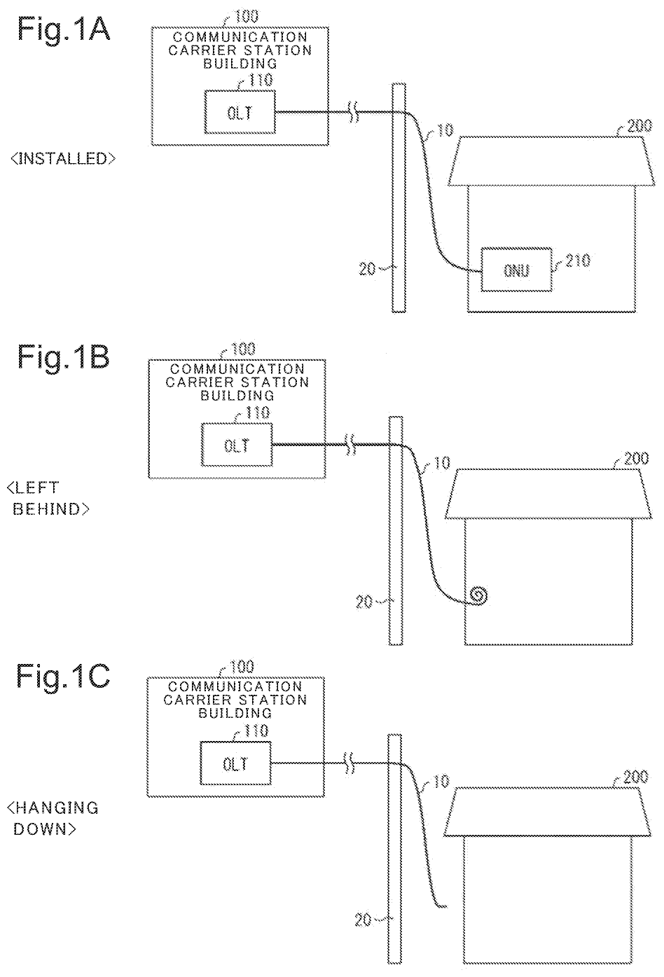

First, hanging down of an optical fiber will be described. FIG. 1 is a diagram illustrating an example of each state of an optical fiber 10.

An upper row in FIG. 1 illustrates a state where the optical fiber 10 is “installed”. As illustrated in the upper row in FIG. 1, the optical fiber 10 connected to an optical line termination (OLT) 110 disposed in a communication carrier station building 100 is wired in an aerial manner via a predetermined route, is drawn into a house 200 from a utility pole 20 near the house 200, and is connected to an optical network unit (ONU) 210 disposed in the house 200. The OLT 110 is connected to a network of a communication carrier. A subscriber can connect a desired information processing terminal to the ONU 210 by installing the optical fiber 10, and can perform communication via the optical fiber 10.

A middle row in FIG. 1 illustrates a state where the optical fiber 10 is “left behind”. As illustrated in the middle row in FIG. 1, an end portion of the optical fiber 10 drawn into the house 200 is housed in the house 200 without being connected to the ONU 210. In many cases, the optical fiber 10 in the house 200 is in a wound state. Such a state occurs when a subscriber installs the optical fiber 10, then cancels a contract with a communication carrier, removes the ONU 210, and leaves the end portion of the optical fiber 10 in the house 200.

A lower row in FIG. 1 illustrates a state where “hanging down” occurs in the optical fiber 10 being left behind. As illustrated in the lower row in FIG. 1, a drawn portion of the optical fiber 10 into a house is not drawn into the house 200 and hangs down from the utility pole 20.

In this way, a state where an optical fiber hangs down from a portion being wired in an aerial manner is referred to as “hanging down”. As described above, a drawn portion of an optical fiber being drawn into a house from an outdoor aerial wire may hang down due to weight of snow and an influence of a typhoon and the like. When this state is left as it is, the optical fiber hanging down may contact a pedestrian and the like, which may result in an accident.

Thus, it is important to identify hanging down of an optical fiber. Under present circumstances, recognition of an occurrence of hanging down of an optical fiber and identification of an occurrence place are generally performed by contact from a person who finds hanging down of the optical fiber and a field survey based on the contact. However, this method increases a human cost, cannot identify hanging down of an optical fiber at an early stage, and also increases a risk of an occurrence of an accident.

In contrast, the identification system according to the present example embodiment can identify hanging down of an optical fiber, and thus an optical fiber can be maintained and maintenance can be made more efficient. Note that identification of hanging down of an optical fiber refers to identification of an occurrence of hanging down of the optical fiber or identification of a non-occurrence of hanging down of the optical fiber, and may be a determination of presence or absence of hanging down of the optical fiber in one aspect.

### (Outline of Identification System)

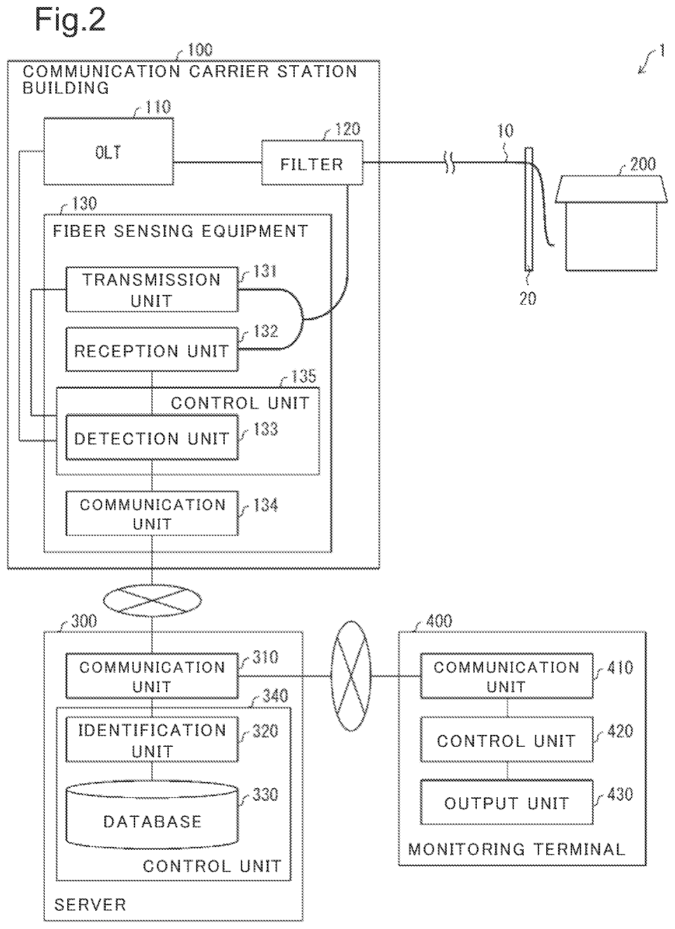

FIG. 2 is a diagram illustrating one example of a schematic configuration of an identification system 1 according to the first example embodiment. As illustrated in FIG. 2, the identification system 1 is an identification system added to an optical communication system including the optical fiber 10 and the OLT 110, and includes a filter 120, fiber sensing equipment 130, a server 300, and a monitoring terminal 400. The OLT 110, the filter 120, and the fiber sensing equipment 130 are disposed in the communication carrier station building 100. In the present example embodiment, description is given on an assumption that the optical fiber 10 connected to the OLT 110 is wired in an aerial manner via any route and hangs down from the utility pole 20 near the house 200.

The fiber sensing equipment 130 includes a control unit 135, a transmission unit 131, a reception unit 132, and a communication unit 134. The control unit 135 includes a detection unit 133.

The control unit 135 collectively controls each configuration of the fiber sensing equipment 130. In one aspect, the control unit 135 may acquire a use situation of the optical fiber 10 from the OLT 110, and may operate each configuration when the optical fiber 10 is a left fiber. Note that the use situation of the optical fiber 10 is information indicating whether the optical fiber 10 is installed or left behind.

The transmission unit 131 is a light source, and outputs pulse light. The pulse light output from the transmission unit 131 enters the optical fiber 10 via the filter 120. In this way, the transmission unit 131 can transmit pulse light via the optical fiber 10.

The reception unit 132 is an optical detector. Backscattered light of the pulse light generated in the optical fiber 10 enters the reception unit 132 via the filter 120. In this way, the reception unit 132 can receive, from the optical fiber 10, the backscattered light of the pulse light transmitted from the transmission unit 131. The reception unit 132 converts the received backscattered light into an electric signal, and outputs the electric signal to the detection unit 133.

Note that a wavelength λ1 of the pulse light transmitted from the transmission unit 131 via the optical fiber 10 is preferably a wavelength sufficiently separated from a wavelength λ0 being used for communication by the OLT 110 via the optical fiber 10.

The filter 120 is a wavelength division multiplexing (WDM) filter provided on the optical fiber 10, and transmits, as it is, an optical signal having a wavelength in a predetermined range with the wavelength λ0 as the center at which light propagates through the optical fiber 10. On the other hand, for an optical signal having a wavelength in a predetermined range with the wavelength λ1 as the center, the filter 120 causes (i) the pulse light output from the transmission unit 131 to enter the optical fiber 10 in a direction opposite to the OLT 110, and also causes (ii) the backscattered light of the pulse light propagating through the optical fiber 10 toward the OLT 110 side to enter the reception unit 132. Note that, instead of the filter 120, various optical components may be combined and used in such a way as to achieve an equivalent function.

The detection unit (acquisition unit) 133 detects an environmental state around the optical fiber 10 from a signal (information indicating the backscattered light) indicating the backscattered light being acquired from the reception unit 132. In the present example embodiment, the environmental state being detected by the detection unit 133 is a vibration. The detection unit 133 calculates, from the signal indicating the backscattered light, intensity of Rayleigh scattered light having the same wavelength λ1 as the pulse light. The intensity of the Rayleigh scattered light changes in response to a vibration of the optical fiber 10, and thus the detection unit 133 can detect a vibration of the optical fiber 10.

Further, an interval since the transmission unit 131 transmits the pulse light until the reception unit 132 receives the backscattered light is an interval according to an occurrence position of the backscattered light. Thus, the detection unit 133 can calculate an occurrence position of the backscattered light from a time difference between a transmission timing of the pulse light and a reception timing of the backscattered light associated with the pulse light. In this way, the detection unit 133 can detect each vibration of the optical fiber 10 in a plurality of positions on the optical fiber 10.

Then, the transmission unit 131 repeatedly transmits the pulse light, and thus the detection unit 133 can detect, in time series, a vibration of the optical fiber 10 in a plurality of positions on the optical fiber 10.

The communication unit 134 performs communication with the server 300 via a network. The control unit 135 transmits, to the server 300 via the communication unit 134, information indicating the vibration of the optical fiber 10 being detected by the detection unit 133. Further, in one aspect, the control unit 135 may also transmit positional information data about the optical fiber 10 to the server 300. The positional information data about the optical fiber 10 are, for example, information indicating the utility pole 20 near the house 200 in which the optical fiber 10 is left behind.

The server 300 includes a control unit 340 and a communication unit 310. The control unit 340 includes an identification unit 320 and a database 330.

The control unit 340 collectively controls each configuration of the server 300. The communication unit 310 performs communication with the fiber sensing equipment 130 and the monitoring terminal 400 via a network. The control unit 340 provides, to the identification unit 320, the information indicating the vibration of the optical fiber 10 and the positional information data that are received from the fiber sensing equipment 130 via the communication unit 310. The identification unit 320 refers to information stored in the database 330, and identifies hanging down of the optical fiber 10 from the vibration of the optical fiber 10. Details of the identification will be described later. Further, when the identification unit 320 identifies an occurrence of hanging down in the optical fiber 10, the identification unit 320 may identify a position indicated by the positional information data as a position of hanging down of the optical fiber 10.

Then, the control unit 340 transmits, to the monitoring terminal 400 via the communication unit 310, an identification result of hanging down of the optical fiber 10 by the identification unit 320, and an identification result of a position of the hanging down when the identification unit 320 identifies the position of the hanging down of the optical fiber 10.

The monitoring terminal 400 includes a control unit 420, a communication unit 410, and an output unit 430. The control unit 420 collectively controls each configuration of the monitoring terminal 400. The communication unit 410 performs communication with the server 300 via a network. The output unit 430 includes a display device such as a display or a sound output device such as a speaker, and outputs various pieces of information. The control unit 420 causes the output unit 430 to output the identification result of hanging down of the optical fiber 10 and the identification result of the position of hanging down of the optical fiber 10 that are received from the server 300 via the communication unit 410.

### (Operation of Identification System)

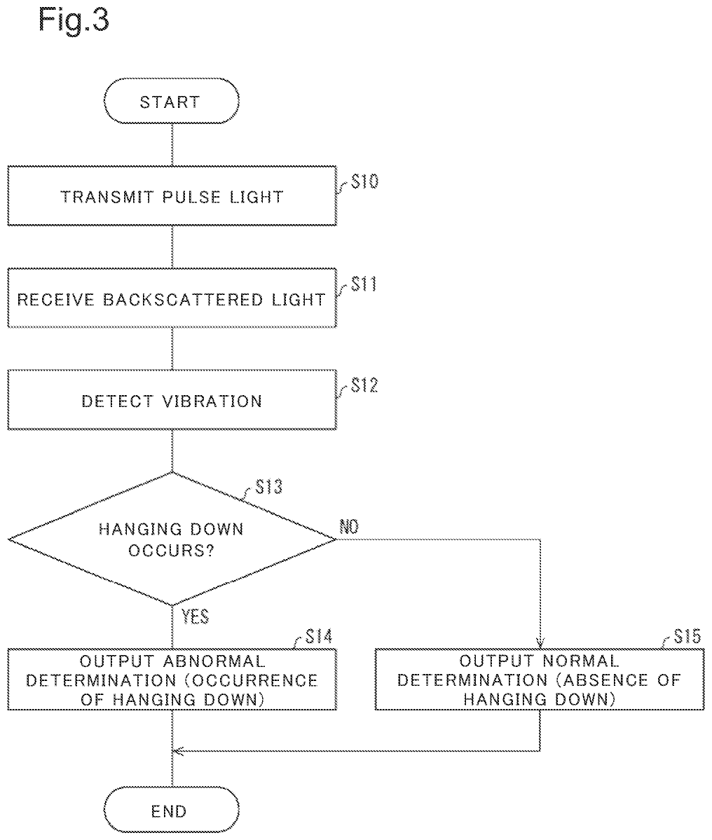

Subsequently, an operation of the identification system 1 will be described. FIG. 3 is a flowchart illustrating one example of the operation of the identification system 1. In the present example embodiment, the identification system 1 identifies hanging down of the optical fiber 10, based on a vibration of the optical fiber 10.

First, the transmission unit 131 of the fiber sensing equipment 130 transmits pulse light via the optical fiber 10 (step S10). Since a hanging-down portion of the optical fiber 10 is not fixed, a great vibration is generated in the hanging-down portion due to wind and the like. Thus, when the pulse light is transmitted via the optical fiber 10, backscattered light including Rayleigh scattered light is generated in the hanging-down portion of the optical fiber 10 in response to a vibration of the hanging-down portion.

The reception unit 132 of the fiber sensing equipment 130 receives the backscattered light (step S11). The reception unit 132 converts the received backscattered light into an electric signal, and outputs the electric signal to the detection unit 133 of the fiber sensing equipment 130.

The detection unit 133 detects a vibration of the optical fiber 10 from the signal (information indicating the backscattered light) indicating the backscattered light being acquired from the reception unit 132 (step S12). The detection unit 133 calculates, from (i) the signal indicating the backscattered light, intensity of the Rayleigh scattered light having the same wavelength λ1 as the pulse light, and also calculates an occurrence position of the backscattered light from (i) a time difference between a transmission timing of the pulse light and a reception timing of the backscattered light associated with the pulse light. In this way, the detection unit 133 detects, in time series, a vibration of the optical fiber 10 in a plurality of positions on the optical fiber 10. The control unit 135 of the fiber sensing equipment 130 transmits, to the server 300 via the communication unit 134 of the fiber sensing equipment 130, information indicating the vibration of the optical fiber 10 being detected by the detection unit 133.

The control unit 340 of the server 300 provides, to the identification unit 320 of the server 300, the information indicating the vibration of the optical fiber 10 being received from the fiber sensing equipment 130 via the communication unit 310 of the server 300. The identification unit 320 refers to data stored in the database 330 of the server 300, and identifies hanging down of the optical fiber 10 from the information indicating the vibration of the optical fiber 10 (step S13).

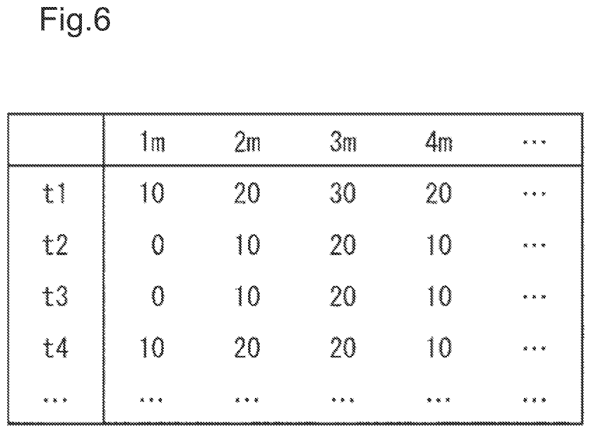

FIG. 6 is a diagram illustrating one example of a data structure of information indicating a vibration of the optical fiber 10. A row in FIG. 6 indicates a value associated with each point in time, and a column indicates a value associated with each position. The information indicating a vibration of the optical fiber 10 is information indicating a result of detecting, in time series, a vibration of the optical fiber 10 in a plurality of positions on the optical fiber 10 by the detection unit 133, and includes, in time series, a value indicating a vibration of the optical fiber 10 for each of the plurality of positions on the optical fiber 10 as illustrated in FIG. 6. For example, a value indicating a vibration of the optical fiber 10 may be a value associated with intensity of Rayleigh scattered light, or may be a value indicating an amplitude of the vibration.

In one aspect, the identification unit 320 refers to information indicating a vibration of the optical fiber 10, and identifies, from a time fluctuation in a vibration in a certain position on the optical fiber 10, hanging down of the optical fiber 10 in the certain position. A time fluctuation in a vibration can also be referred to as data about a value indicating a vibration in time series. For example, the identification unit 320 may use, as the certain position, a position on the optical fiber 10 farthest from the OLT 110 or a vicinity of the position, or may identify hanging down of the optical fiber 10 for each of a plurality of positions.

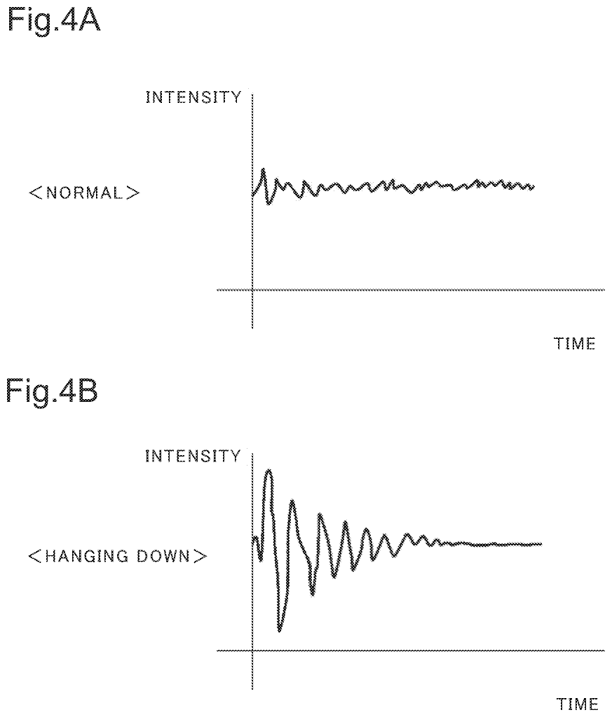

FIG. 4 is a diagram illustrating an example of a time fluctuation in a vibration in a certain position on the optical fiber 10. In a graph in FIG. 4, a horizontal axis indicates time, and a vertical axis indicates a value associated with intensity of Rayleigh scattered light. An upper row in FIG. 4 illustrates one example when the optical fiber 10 does not hang down in the certain position, and a lower row in FIG. 4 illustrates one example when the optical fiber 10 hangs down in the certain position.

As illustrated in FIG. 4, an amplitude of a vibration in the certain position on the optical fiber 10 is greater when the optical fiber 10 hangs down in the certain position than that when the optical fiber 10 does not hang down. The reason is that, when the optical fiber 10 hangs down, the optical fiber 10 is not fixed and thus tends to vibrate greatly. Thus, for example, a threshold value of an amplitude is predetermined, and, when an amplitude of a vibration in the certain position on the optical fiber 10 exceeds the threshold value, the identification unit 320 may identify an occurrence of hanging down of the optical fiber 10 in the certain position.

Further, as illustrated in FIG. 4, a period of time since an amplitude of a vibration in the certain position on the optical fiber 10 becomes a maximum value until the amplitude is reduced by half is longer when the optical fiber 10 hangs down in the certain position than that when the optical fiber 10 does not hang down. The reason is that, when the optical fiber 10 hangs down, the optical fiber 10 is not fixed and thus attenuation of a vibration tends to be slow. Thus, for example, a threshold value of a period of time since an amplitude of a vibration becomes a maximum value until the amplitude is reduced by half is predetermined, and, when a period of time since an amplitude of a vibration in the certain portion on the optical fiber 10 becomes a maximum value until the amplitude is reduced by half exceeds the threshold value, the identification unit 320 may identify an occurrence of hanging down of the optical fiber 10 in the certain position.

Further, as illustrated in FIG. 4, it can be said that a pattern of a time fluctuation in a vibration varies between when the optical fiber 10 does not hang down and when the optical fiber 10 hangs down. Thus, the identification unit 320 may identify hanging down of the optical fiber 10 by using a learning model in such a way as to detect a pattern of a time fluctuation in a vibration occurring when the optical fiber 10 hangs down, including a pattern as illustrated in the lower row in FIG. 4. Further, the identification unit 320 may identify hanging down of the optical fiber 10 by using a learning model of learning a relationship between a time fluctuation in a vibration of the optical fiber 10 in a certain position on the optical fiber 10 and presence or absence of hanging down of the optical fiber 10, instead of performing a determination based on a rule.

Each of the threshold values described above may be preset for the identification unit 320. Further, the identification unit 320 may learn, in advance, information indicating a vibration of the optical fiber 10 in a state where hanging down of the optical fiber 10 does not occur, and may set a threshold value.

Further, in another aspect, the identification unit 320 refers to information indicating a vibration of the optical fiber 10, and identifies, from a spatial distribution of a vibration of the optical fiber 10 at a certain point in time, hanging down of the optical fiber 10 at the certain point in time. A spatial distribution of a vibration can also be referred to as data indicating a vibration in each of a plurality of positions on the optical fiber 10.

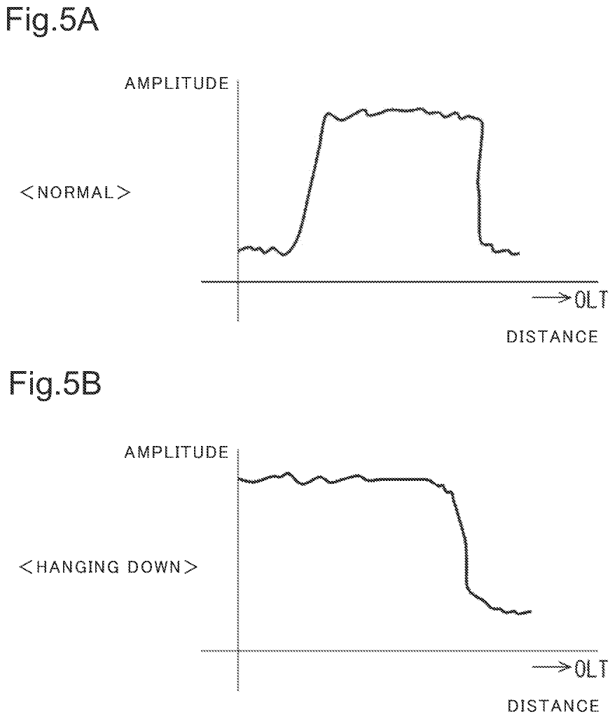

FIG. 5 is a diagram illustrating an example of a spatial distribution of a vibration of the optical fiber 10 at a certain point in time. In a graph in FIG. 5, a horizontal axis indicates a position, and a vertical axis indicates an amplitude of a vibration. The position is indicated by a distance from a position on the optical fiber 10 farthest from the OLT 110. An upper row in FIG. 5 illustrates one example when the optical fiber 10 does not hang down at the certain point in time, and a lower row in FIG. 5 illustrates one example when the optical fiber 10 hangs down at the certain point in time. In particular, the lower row in FIG. 5 illustrates an example when a drawn portion of the optical fiber 10 hangs down.

As illustrated in FIG. 5, it can be said that a pattern of a spatial distribution of a vibration varies between when the optical fiber 10 does not hang down and when the drawn portion of the optical fiber 10 hangs down. In particular, an amplitude in the position on the optical fiber 10 farthest from the OLT 110 and in a vicinity of the position when the optical fiber 10 does not hang down is extremely small, whereas the amplitude increases when the drawn portion of the optical fiber 10 hangs down. The reason is that a vibration is hardly generated in the position on the optical fiber 10 farthest from the OLT 110 and in the vicinity of the position because the drawn portion of the optical fiber 10 is housed in the house 200 when the drawn portion does not hang down, whereas a great vibration is generated when the drawn portion of the optical fiber 10 hangs down.

Thus, the identification unit 320 may identify hanging down of the optical fiber 10 by using a learning model in such a way as to detect a pattern of a spatial distribution of a vibration occurring when the optical fiber 10 hangs down, including a pattern as illustrated in the lower row in FIG. 5. Further, the identification unit 320 may identify hanging down of the optical fiber 10 by using a learning model of learning a relationship between a spatial distribution of a vibration of the optical fiber 10 at a certain point in time of a vibration of the optical fiber 10 and presence or absence of hanging down of the optical fiber 10, instead of performing a determination based on a rule.

Note that, when a drawn portion of the optical fiber 10 hangs down and the optical fiber 10 further hanging down comes into contact with the ground, a vibration of a portion in contact with the ground decreases. The identification unit 320 may identify hanging down of the optical fiber 10 by also detecting, as a pattern of a spatial distribution of a vibration occurring when the optical fiber 10 hangs down, a pattern of a spatial distribution of a vibration in such a case.

Further, the identification unit 320 may identify hanging down of the optical fiber 10 by using a learning model of learning a relationship between a vibration of the optical fiber 10 being detected in time series in a plurality of positions on the optical fiber 10 and presence or absence of hanging down of the optical fiber 10. Each of the learning models described above can be stored in advance in the database 330.

As described above, when the identification unit 320 identifies an occurrence of hanging down of the optical fiber 10 (YES in step S13), the control unit 340 transmits an identification result that hanging down occurs to the monitoring terminal 400 via the communication unit 310. The control unit 420 of the monitoring terminal 400 causes the output unit 430 to output an abnormal determination (occurrence of hanging down), based on the identification result received by the communication unit 410 of the monitoring terminal 400 (step S14).

When the identification unit 320 identifies a position of hanging down of the optical fiber 10, the control unit 340 may transmit the identification result to the monitoring terminal 400 via the communication unit 310, and the control unit 420 may cause the output unit 430 to output the identified position of hanging down of the optical fiber 10.

When the identification unit 320 identifies a non-occurrence of hanging down of the optical fiber 10 (NO in step S13), the control unit 340 transmits an identification result that hanging down does not occur to the monitoring terminal 400 via the communication unit 310. The control unit 420 causes the output unit 430 to output a normal determination (absence of hanging down), based on the identification result received by the communication unit 410 (step S15).

As described above, the identification system 1 can identify hanging down of the optical fiber 10, and output an identification result. In this way, an optical fiber can be maintained and maintenance can be made more efficient.

### Modification Example

As described above, in the identification system 1, the identification unit 320 can identify hanging down of the optical fiber 10 from information indicating at least one of (i) a time fluctuation in a certain position on the optical fiber 10 and (ii) a spatial distribution on the optical fiber 10 at a certain point in time, of a vibration of the optical fiber 10. Thus, the detection unit 133 may detect at least one of (i) a time fluctuation in a certain position on the optical fiber 10 and (ii) a spatial distribution on the optical fiber 10 at a certain point in time, of a vibration of the optical fiber 10.

Further, in the identification system 1, the fiber sensing equipment 130 includes the detection unit 133, and the server 300 includes the identification unit 320 and the database 330, but the present example embodiment is not limited to this and can have various configurations.

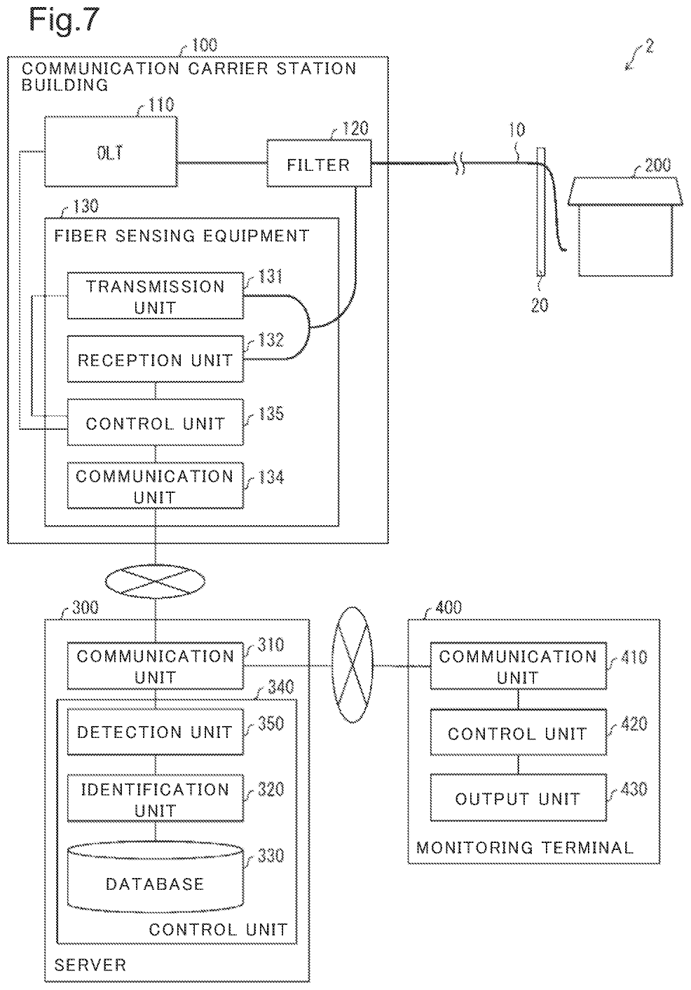

FIG. 7 is a diagram illustrating a schematic configuration of an identification system 2 according to one modification example. FIG. 7 is a configuration that achieves so-called cloud computing, and in the identification system 2, the control unit 135 of the fiber sensing equipment 130 does not include the detection unit 133, and, instead of this, the control unit 340 of the server (identification device) 300 includes a detection unit 350 having a function equivalent to that of the detection unit 133.

The control unit 135 of the fiber sensing equipment 130 transmits, to the server 300 via the communication unit 134, information indicating backscattered light being generated by the reception unit 132. The control unit (acquisition unit) 340 of the server 300 acquires the information indicating the backscattered light being received via the communication unit 310, and provides the information to the detection unit 350. In this way, similarly to the identification system 1, the identification system 2 can identify hanging down of the optical fiber 10, and output an identification result.

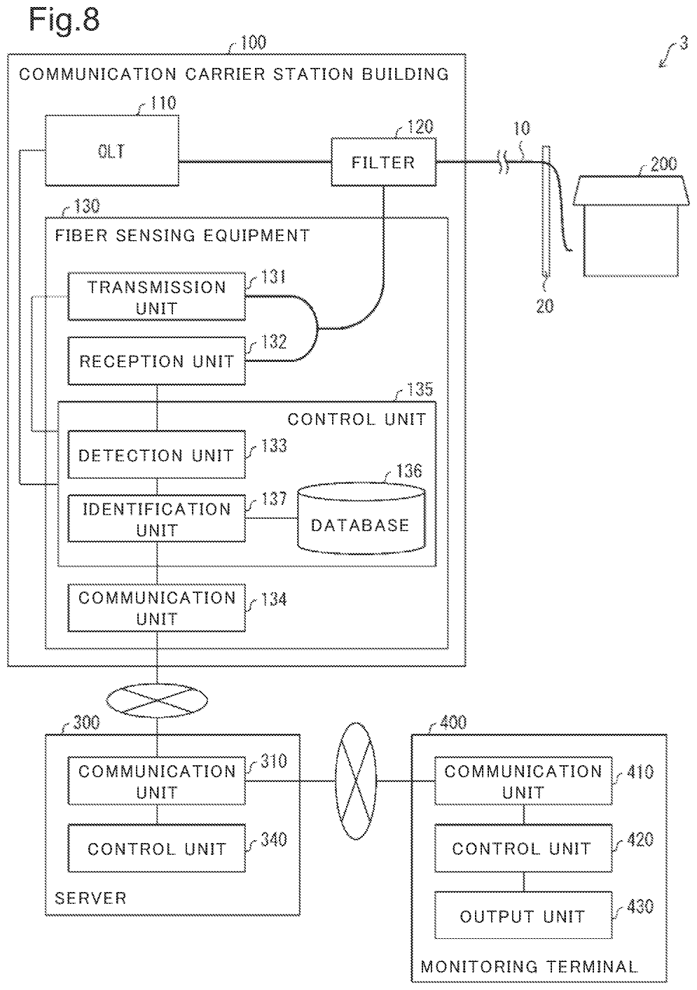

FIG. 8 is a diagram illustrating a schematic configuration of an identification system 3 according to another modification example. FIG. 8 is a configuration that achieves so-called cloud computing, and the control unit 340 of the server 300 does not include the identification unit 320 and the database 330, and, instead, the control unit 135 of the fiber sensing equipment (identification device) 130 includes an identification unit 137 having a function equivalent to that of the identification unit 320 and a database 136 having a function equivalent to that of the database 330.

The identification unit 137 of the fiber sensing equipment 130 identifies hanging down of the optical fiber 10 from information indicating a vibration of the optical fiber 10 being calculated by the detection unit 133. The control unit 135 transmits, to the server 300 via the communication unit 134, an identification result of hanging down of the optical fiber 10. The control unit 340 of the server 300 transmits, to the monitoring terminal 400 via the communication unit 310, the identification result of hanging down of the optical fiber 10 being received via the communication unit 310. In this way, similarly to the identification system 1, the identification system 3 can identify hanging down of the optical fiber 10, and output an identification result.

In addition, the fiber sensing equipment 130, the server 300, and the monitoring terminal 400 may be directly connected without passing through a network, or any combination of two or all may be integrally formed.

Further, in the identification system 1, a drawn portion of the optical fiber 10 being a left fiber is identified, but the present example embodiment is not limited to this, and hanging down of the optical fiber 10 being installed may be identified. An abnormality in the optical fiber 10 being installed can be detected from a communication situation by the OLT 110, but the identification system 1 may be further configured to identify hanging down of the optical fiber 10.

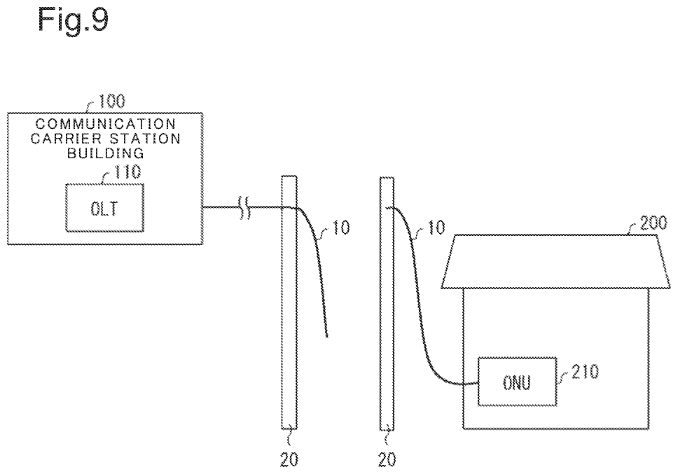

Further, as illustrated in FIG. 9, in the optical fiber 10, hanging down may occur in not only a drawn portion but also a portion ruptured on the way. A rupture of the optical fiber 10 can be detected from reflected light at an end surface of the optical fiber 10, but the identification system 1 may be further configured to identify hanging down due to a rupture of the optical fiber 10. Even for hanging down due to a rupture of the optical fiber 10, a time fluctuation in a vibration of the optical fiber 10 has the pattern illustrated in FIG. 4, and thus hanging down can be identified by the identification system 1.

### Second Example Embodiment

A second example embodiment being another example embodiment according to the present invention will be described below. In the first example embodiment, the configuration in which the identification system detects a vibration of an optical fiber and identifies hanging down of the optical fiber is described, but a target detected by the identification system is not limited to a vibration of an optical fiber.

In other words, the identification system may detect an environmental state around an optical fiber and identify hanging down of the optical fiber. Examples of the environmental state around an optical fiber include, for example, a vibration, a sound, pressure, a temperature, and the like, and the identification system may detect a vibration and a sound around an optical fiber from intensity of Rayleigh scattered light included in backscattered light of pulse light incident on the optical fiber, may detect pressure around the optical fiber from a frequency shift amount of Brillouin scattered light included in the backscattered light, or may detect a temperature around the optical fiber from intensity of Raman scattered light included in the backscattered light. Then, the identification system may identify hanging down of the optical fiber from the environmental states around the optical fiber.

In the present example embodiment, a configuration in which the identification system detects a temperature of an optical fiber and identifies hanging down of the optical fiber will be described. Note that, for convenience of description, a member having the same function as that of the member described in the example embodiment described above is denoted by the same reference sign, and description thereof is not repeated.

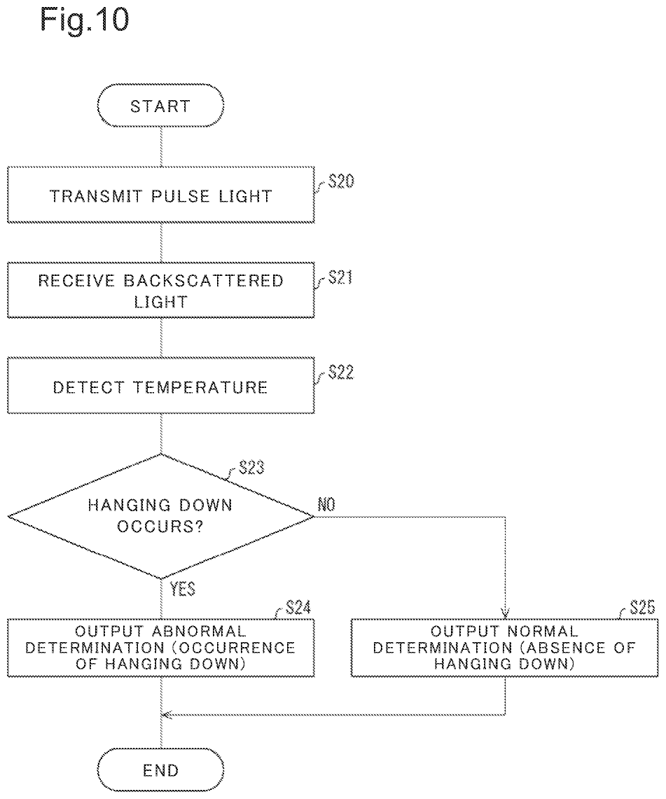

FIG. 10 is a flowchart illustrating one example of an operation of an identification system according to the second example embodiment.

First, a transmission unit 131 of fiber sensing equipment 130 transmits pulse light via an optical fiber 10 (step S20). Since a hanging-down portion of the optical fiber 10 is not housed in a house 200, the hanging-down portion is affected by a temperature outside and a temperature of the hanging-down portion changes as compared to a case where the hanging-down portion is housed in the house 200. Since energy of light propagating through the optical fiber 10 is changed by a temperature in the optical fiber 10, backscattered light including Raman scattered light having intensity according to the temperature of the optical fiber 10 is generated.

A reception unit 132 of the fiber sensing equipment 130 receives the backscattered light (step S21). The reception unit 132 converts the received backscattered light into an electric signal, and outputs the electric signal to a detection unit 133 of the fiber sensing equipment 130.

The detection unit 133 detects the temperature of the optical fiber 10 from the signal (information indicating the backscattered light) indicating the backscattered light being acquired from the reception unit 132 (step S22). The detection unit 133 calculates, from (i) the signal indicating the backscattered light, intensity of Raman scattered light having a wavelength associated with a wavelength λ1 of the pulse light, and also calculates an occurrence position of the backscattered light from (i) a time difference between a transmission timing of the pulse light and a reception timing of the backscattered light associated with the pulse light. In this way, the detection unit 133 detects, in time series, a temperature of the optical fiber 10 in a plurality of positions on the optical fiber 10. A control unit 135 of the fiber sensing equipment 130 transmits, to a server 300 via a communication unit 134 of the fiber sensing equipment 130, information indicating the temperature of the optical fiber 10 being detected by the detection unit 133.

A control unit 340 of the server 300 provides, to an identification unit 320 of the server 300, the information indicating the temperature of the optical fiber 10 being received from the fiber sensing equipment 130 via a communication unit 310 of the server 300. The identification unit 320 refers to data stored in a database 330 of the server 300, and identifies hanging down of the optical fiber 10 from the information indicating the temperature of the optical fiber 10 (step S23).

A data structure of information indicating a temperature of the optical fiber 10 is similar to the structure illustrated in FIG. 6. In other words, the information indicating a temperature of the optical fiber 10 is information indicating a result of detecting, in time series, a temperature of the optical fiber 10 in a plurality of positions on the optical fiber 10 by the detection unit 133, and includes, in time series, a value indicating a temperature of the optical fiber 10 for each of the plurality of positions on the optical fiber 10.

In one aspect, the identification unit 320 refers to information indicating a temperature of the optical fiber 10, and identifies, from a time fluctuation in a temperature in a certain position on the optical fiber 10, hanging down of the optical fiber 10 in the certain position. A time fluctuation in a temperature can also be referred to as data about a value indicating a temperature in time series. The identification unit 320 preferably uses, as the certain position, a position on the optical fiber 10 farthest from an OLT 110 or a vicinity of the position.

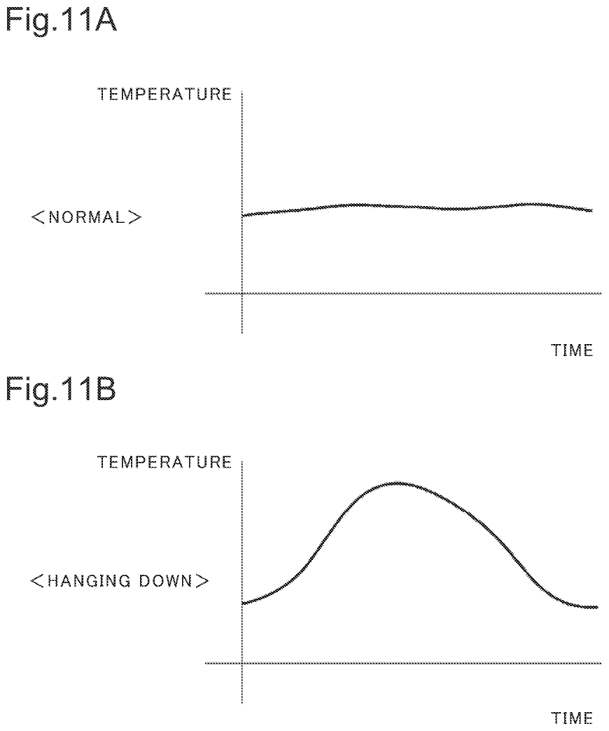

FIG. 11 is a diagram illustrating an example of a time fluctuation in a temperature of a drawn portion on the optical fiber 10. In a graph in FIG. 11, a horizontal axis indicates time, and a vertical axis indicates a temperature. An upper row in FIG. 4 illustrates one example when the optical fiber 10 does not hang down in the drawn portion, and a lower row in FIG. 4 illustrates one example when the optical fiber 10 hangs down in the drawn portion.

As illustrated in FIG. 11, it can be said that a pattern of a time fluctuation in a temperature varies between when the optical fiber 10 does not hang down and when the drawn portion of the optical fiber 10 hangs down. The reason is that, when the drawn portion of the optical fiber 10 hangs down, the drawn portion is affected by a temperature outside and a change in temperature of the drawn portion increases as compared to a case where the optical fiber 10 does not hang down. Note that FIG. 11 illustrates a case where a temperature of the drawn portion of the optical fiber 10 increases when the drawn portion hangs down as compared to a case where the optical fiber 10 does not hang down, but, depending on a temperature of the outside air, a temperature of the drawn portion of the optical fiber 10 may decrease when the drawn portion hangs down as compared to a case where the optical fiber 10 does not hang down.

Thus, the identification unit 320 may identify hanging down of the optical fiber 10 by using a learning model in such a way as to detect a pattern of a time fluctuation in a temperature occurring when the optical fiber 10 hangs down, including a pattern as illustrated in the lower row in FIG. 11. Further, the identification unit 320 may identify hanging down of the optical fiber 10 by using a learning model of learning a relationship between a time fluctuation in a temperature in a certain position on the optical fiber 10 of a temperature of the optical fiber 10 and presence or absence of hanging down of the optical fiber 10, instead of performing a determination based on a rule.

Further, in another aspect, the identification unit 320 refers to information indicating a temperature of the optical fiber 10, and identifies, from a spatial distribution of a temperature of the optical fiber 10 at a certain point in time, hanging down of the optical fiber 10 at the certain point in time. A spatial distribution of a temperature can also be referred to as data indicating a temperature in each of a plurality of positions on the optical fiber 10.

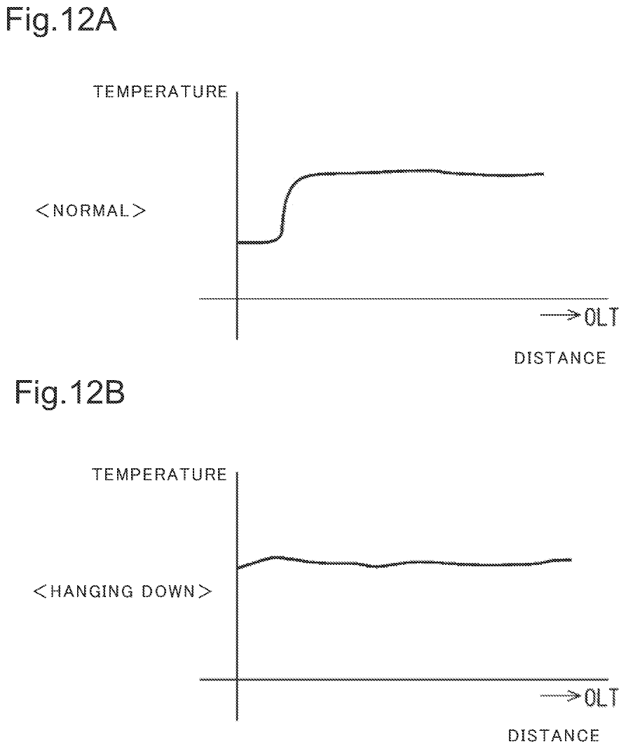

FIG. 12 is a diagram illustrating an example of a spatial distribution of a temperature of the optical fiber 10 at a certain point in time. In a graph in FIG. 12, a horizontal axis indicates a position, and a vertical axis indicates a temperature. The position is indicated by a distance from a position on the optical fiber 10 farthest from the OLT 110. An upper row in FIG. 12 illustrates one example when the optical fiber 10 does not hang down at the certain point in time, and a lower row in FIG. 12 illustrates one example when the optical fiber 10 hangs down at the certain point in time. In particular, the lower row in FIG. 12 illustrates an example when a drawn portion of the optical fiber 10 hangs down.

As illustrated in FIG. 12, it can be said that a pattern of a spatial distribution of a temperature varies between when the optical fiber 10 does not hang down and when the drawn portion of the optical fiber 10 hangs down. In particular, a temperature in the position on the optical fiber 10 farthest from the OLT 110 and in a vicinity of the position when the optical fiber 10 does not hang down is different from a temperature in another portion, whereas the temperature is not different from that in the another portion when the drawn portion of the optical fiber 10 hangs down. The reason is that a temperature in the position on the optical fiber 10 farthest from the OLT 110 and in the vicinity of the position is different from a temperature of the optical fiber 10 outside because the drawn portion of the optical fiber 10 is housed in the house 200 when the drawn portion does not hang down, whereas the temperature becomes a temperature similar to that of the optical fiber 10 outside when the drawn portion of the optical fiber 10 hangs down.

Thus, the identification unit 320 may identify hanging down of the optical fiber 10 by using a learning model in such a way as to detect a pattern of a spatial distribution of a temperature occurring when the optical fiber 10 hangs down, including a pattern as illustrated in the lower row in FIG. 12. Further, the identification unit 320 may identify hanging down of the optical fiber 10 by using a learning model of learning a relationship between a spatial distribution of a temperature of the optical fiber 10 at a certain point in time of a temperature of the optical fiber 10 and presence or absence of hanging down of the optical fiber 10, instead of performing a determination based on a rule.

Further, the identification unit 320 may identify hanging down of the optical fiber 10 by using a learning model of learning a relationship between a temperature of the optical fiber 10 being detected in time series in a plurality of positions on the optical fiber 10 and presence or absence of hanging down of the optical fiber 10. Each of the learning models described above can be stored in advance in the database 330.

As described above, when the identification unit 320 identifies an occurrence of hanging down of the optical fiber 10 (YES in step S23), the control unit 340 transmits an identification result that hanging down occurs to a monitoring terminal 400 via the communication unit 310. A control unit 420 of the monitoring terminal 400 causes an output unit 430 to output an abnormal determination (occurrence of hanging down), based on the identification result received by a communication unit 410 of the monitoring terminal 400 (step S24).

Similarly to the first example embodiment, the identification unit 320 may identify a position of hanging down of the optical fiber 10, and, in this case, the control unit 340 may transmit the identification result to the monitoring terminal 400 via the communication unit 310, and the control unit 420 may cause the output unit 430 to output the identified position of hanging down of the optical fiber 10.

When the identification unit 320 identifies a non-occurrence of hanging down of the optical fiber 10 (NO in step S23), the control unit 340 transmits an identification result that hanging down does not occur to the monitoring terminal 400 via the communication unit 310. The control unit 420 causes the output unit 430 to output a normal determination (absence of hanging down), based on the identification result received by the communication unit 410 (step S25).

As described above, the identification system according to the second example embodiment can also identify hanging down of the optical fiber 10, and output an identification result.

### Third Example Embodiment

Another example embodiment according to the present invention will be described below. The configuration in which an optical fiber does not have a branch is described in the first example embodiment, but a configuration in which an optical fiber has a branch will be described in the present example embodiment. Note that, for convenience of description, a member having the same function as that of the member described in the example embodiment described above is denoted by the same reference sign, and description thereof is not repeated.

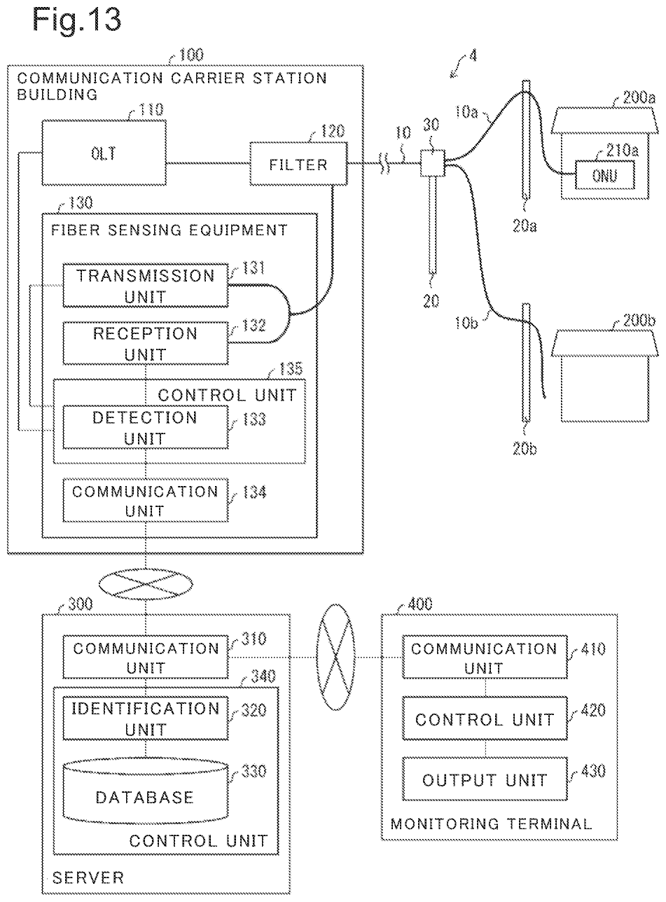

FIG. 13 is a diagram illustrating one example of a schematic configuration of an identification system 4 according to the third example embodiment. In the present example embodiment, an optical fiber 10 connected to an OLT 110 is wired in an aerial manner via any route, and is split into a plurality of branch fibers 10a and 10b by an optical splitter 30. The branch fiber 10a is installed, is drawn into a house 200a from a utility pole 20a near the house 200a, and is connected to an ONU 201a in the house 200a. The branch fiber 10b is a left fiber, and hangs down from a utility pole 20b near a house 200b.

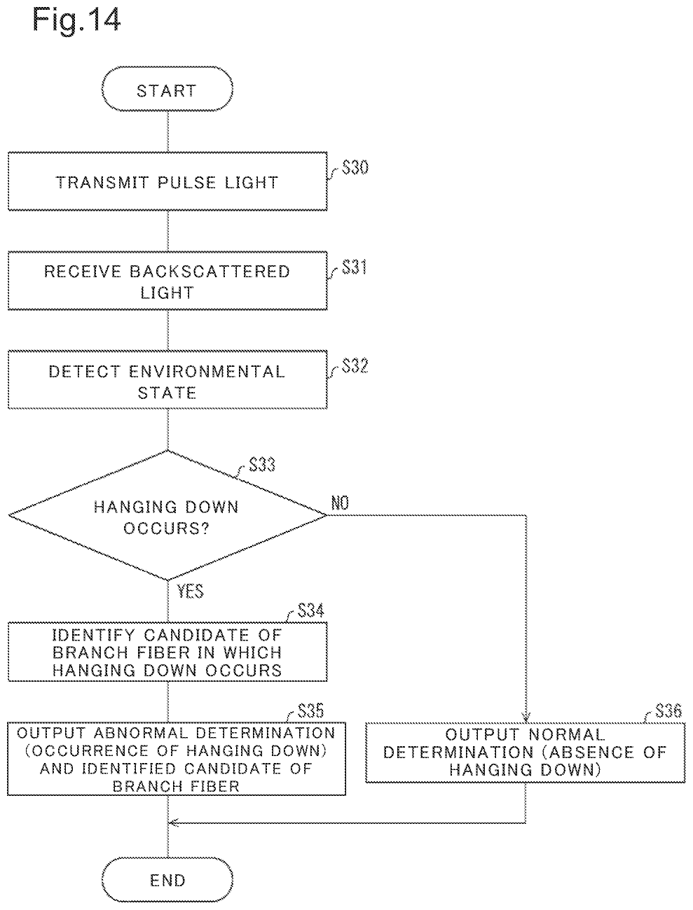

FIG. 14 is a flowchart illustrating one example of an operation of the identification system 4 according to the third example embodiment.

First, a transmission unit 131 of fiber sensing equipment 130 transmits pulse light via the optical fiber 10 (step S30). A reception unit 132 of the fiber sensing equipment 130 receives backscattered light of the pulse light generated in the optical fiber 10 (step S31). The reception unit 132 converts the received backscattered light into an electric signal, and outputs the electric signal to a detection unit 133 of the fiber sensing equipment 130.

Similarly to the first or second example embodiment, the detection unit 133 detects an environmental state around the optical fiber 10 from the signal (information indicating the backscattered light) indicating the backscattered light being acquired from the reception unit 132 (step S32). The detection unit 133 further calculates an occurrence position of the backscattered light from a time difference between a transmission timing of the pulse light and a reception timing of the backscattered light associated with the pulse light. In this way, the detection unit 133 detects, in time series, an environmental state around the optical fiber 10 in a plurality of positions on the optical fiber 10. A control unit 135 of the fiber sensing equipment 130 transmits, to a server 300 via a communication unit 134 of the fiber sensing equipment 130, information indicating the environmental state around the optical fiber 10 being detected by the detection unit 133. The control unit 135 further acquires a use situation of each of the branch fibers 10a and 10b from the OLT 110, and transmits the use situation to the server 300 via the communication unit 134. Note that the use situation of the branch fibers 10a and 10b includes information indicating whether trouble occurs in communication in an installed branch fiber in addition to information indicating whether each of the branch fibers 10a and 10b is installed or left behind.

A control unit 340 of the server 300 provides, to an identification unit 320 of the server 300, the information indicating the environmental state around the optical fiber 10 being received from the fiber sensing equipment 130 via a communication unit 310 of the server 300. Similarly to the first or second example embodiment, the identification unit 320 refers to data stored in a database 330 of the server 300, and identifies hanging down of the optical fiber 10 from the information indicating the environmental state around the optical fiber 10 (step S33).

As described above, when the identification unit 320 identifies an occurrence of hanging down of the optical fiber 10 (YES in step S33), the identification unit 320 identifies a candidate of a branch fiber in which hanging down occurs (step S34). The identification unit 320 refers to the use situation of the branch fibers 10a and 10b being received from the fiber sensing equipment 130 via the communication unit 310, and, when trouble occurs in communication in an installed branch fiber, the identification unit 320 identifies the branch fiber as a candidate of a branch fiber in which hanging down occurs. The identification unit 320 further excludes an installed branch fiber from candidates when trouble does not occur in the installed branch fiber, and identifies a left branch fiber as a candidate of a branch fiber in which hanging down occurs.

The control unit 340 transmits, to a monitoring terminal 400 via the communication unit 310, an identification result that hanging down occurs and an identification result of the candidate of the branch fiber in which hanging down occurs. A control unit 420 of the monitoring terminal 400 causes an output unit 430 to output an abnormal determination (occurrence of hanging down) and the candidate of the branch fiber in which hanging down occurs, based on each of the identification results received by a communication unit 410 of the monitoring terminal 400 (step S35).

Further, similarly to the first example embodiment, the identification unit 320 may identify a position of hanging down of the optical fiber 10, and, in this case, the control unit 340 may transmit the identification result to the monitoring terminal 400 via the communication unit 310, and the control unit 420 may cause the output unit 430 to output the identified position of hanging down of the optical fiber 10.

When the identification unit 320 identifies a non-occurrence of hanging down of the optical fiber 10 (NO in step S33), the control unit 340 transmits an identification result that hanging down does not occur to the monitoring terminal 400 via the communication unit 310. The control unit 420 causes the output unit 430 to output a normal determination (absence of hanging down), based on the identification result received by the communication unit 410 (step S36).

As described above, the identification system 4 according to the third example embodiment can also identify hanging down of the optical fiber 10, and output an identification result. Further, the identification system 4 can identify a candidate of a branch fiber in which hanging down of the optical fiber 10 occurs even when the optical fiber 10 is split.

### Fourth Example Embodiment

Another example embodiment according to the present invention will be described below. Note that, for convenience of description, a member having the same function as that of the member described in the example embodiment described above is denoted by the same reference sign.

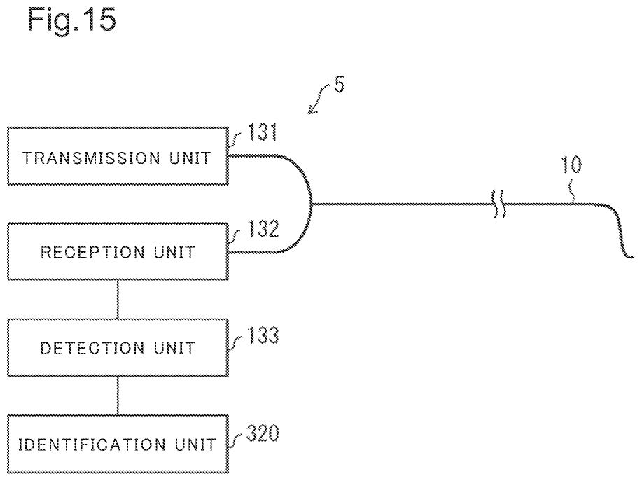

FIG. 15 is a block diagram illustrating a configuration of an identification system 5 according to the present example embodiment. As illustrated in FIG. 15, the identification system 5 includes a transmission unit 131, a reception unit 132, a detection unit 133, and an identification unit 320.

The transmission unit 131 transmits pulse light via an optical fiber 10. The reception unit 132 receives backscattered light of the pulse light from the optical fiber 10. The detection unit 133 detects an environmental state around the optical fiber 10 from the backscattered light. The identification unit 320 identifies hanging down of the optical fiber 10 from a detection result of the detection unit 133.

According to the configuration described above, the identification system 5 can detect an environmental state around the optical fiber 10 from backscattered light associated with pulse light incident on the optical fiber 10, and identify hanging down of the optical fiber 10 from the detection result.

### Fifth Example Embodiment

Another example embodiment according to the present invention will be described below. Note that, for convenience of description, a member having the same function as that of the member described in the example embodiment described above is denoted by the same reference sign.

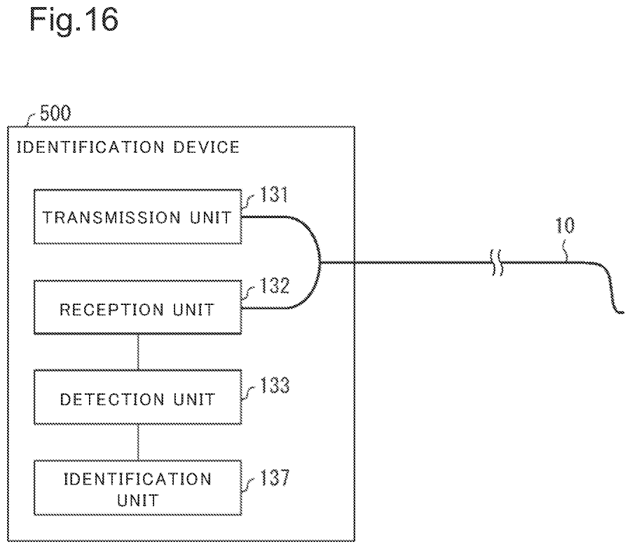

FIG. 16 is a block diagram illustrating a configuration of an identification device 500 according to the present example embodiment. As illustrated in FIG. 16, the identification device 500 includes a transmission unit 131, a reception unit 132, a detection unit 133, and an identification unit 137.

The transmission unit 131 transmits pulse light via an optical fiber 10. The reception unit 132 receives backscattered light of the pulse light from the optical fiber 10. The detection unit 133 detects an environmental state around the optical fiber 10 from the backscattered light. The identification unit 137 identifies hanging down of the optical fiber 10 from a detection result of the detection unit 133.

According to the configuration described above, the identification device 500 can detect an environmental state around the optical fiber 10 from backscattered light associated with pulse light incident on the optical fiber 10, and identify hanging down of the optical fiber 10 from the detection result.

### Achievement Example by Software

A control block (in particular, each unit included in the control units 135, 340, and 420, and the like) of the fiber sensing equipment 130, the server 300, and the monitoring terminal 400 may be achieved by a logical circuit (hardware) formed in an integrated circuit (IC chip) and the like, or may be achieved by software.

In the latter case, the fiber sensing equipment 130, the server 300, and the monitoring terminal 400 include a computer that executes a command of a program being software that achieves each function. The computer includes, for example, one or more processors, and also includes a computer-readable recording medium that stores the program. Then, in the computer, the processor reads the program from the recording medium and executes the program, and thus an object of the present invention is achieved. As the processor, for example, a central processing unit (CPU) can be used. As the recording medium, a “non-transitory tangible medium”, for example, a tape, a disk, a card, a semiconductor memory, a programmable logical circuit, and the like in addition to a read only memory (ROM) can be used. Further, a random access memory (RAM) that develops the program may be further provided. Further, the program may be supplied to the computer via any transmission medium (such as a communication network and a broadcast wave) that can transmit the program. Note that one aspect of the present invention may also be achieved in a form of a data signal embedded in a carrier wave in which the program is embodied by electronic transmission.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### SUPPLEMENTARY NOTE

A part or the whole of each of the above-described example embodiments may also be described as in supplementary notes below, which is not limited thereto.

### (Supplementary Note 1)

An identification system including:

a transmission means for transmitting pulse light via an optical fiber;

a reception means for receiving backscattered light of the pulse light from the optical fiber;

a detection means for detecting an environmental state around the optical fiber from the backscattered light; and

an identification means for identifying hanging down of the optical fiber from a detection result of the detection means.

### (Supplementary Note 2)

The identification system according to supplementary note 1, wherein the environmental state is a vibration.

### (Supplementary Note 3)

The identification system according to supplementary note 1, wherein the environmental state is a temperature.

### (Supplementary Note 4)

The identification system according to any one of supplementary notes 1 to 3, wherein the detection means detects at least one of (i) a time fluctuation in a certain position on the optical fiber and (ii) a spatial distribution on the optical fiber at a certain point in time, of the environmental state.

### (Supplementary Note 5)

The identification system according to any one of supplementary notes 1 to 4, wherein the detection means detects the environmental state in time series in a plurality of positions on the optical fiber.

### (Supplementary Note 6)

The identification system according to any one of supplementary notes 1 to 5, wherein the identification means identifies a position of hanging down of the optical fiber.

### (Supplementary Note 7)

The identification system according to any one of supplementary notes 1 to 6, wherein the optical fiber is a left fiber.

### (Supplementary Note 8)

The identification system according to any one of supplementary notes 1 to 7, wherein hanging down of the optical fiber is hanging down of a drawn portion from an aerial wire into a house.

### (Supplementary Note 9)

The identification system according to any one of supplementary notes 1 to 8, wherein

the optical fiber is split into a plurality of branch fibers by an optical splitter, and

the identification means identifies, from a use situation of each branch fiber, a candidate of a branch fiber in which hanging down occurs.

### (Supplementary Note 10)

The identification system according to any one of supplementary notes 1 to 9, wherein the identification means identifies hanging down of the optical fiber by using a learning model of learning a relationship between the environmental state being detected by the detection means and hanging down of the optical fiber.

### (Supplementary Note 11)

An identification device including:

an acquisition means for acquiring information indicating backscattered light of pulse light being received from an optical fiber to which the pulse light is transmitted;

a detection means for detecting an environmental state around the optical fiber from information indicating the backscattered light; and

an identification means for identifying hanging down of the optical fiber from a detection result of the detection means.

### (Supplementary Note 12)

An identification method including:

transmitting pulse light via an optical fiber;

receiving backscattered light of the pulse light from the optical fiber;

detecting an environmental state around the optical fiber from the backscattered light; and

identifying hanging down of the optical fiber from a result of the detection.

This application is based upon and claims the benefit of priority from Japanese patent application No. 2020-055613, filed on Mar. 26, 2020, the disclosure of which is incorporated herein in its entirety by reference.

### REFERENCE SIGNS LIST

1, 2, 3, 4, 5 Identification system
10 Optical fiber
10a, 10b Branch fiber
30 Optical splitter
130 Fiber sensing equipment
131 Transmission unit
132 Reception unit
133, 350 Detection unit
137, 320 Identification unit
300 Server
400 Monitoring terminal
500 Identification device

What is claimed is:

1. An identification system comprising:
a transmitter configured to transmit pulse light via an optical fiber;
a receiver configured to receive backscattered light of the pulse light from the optical fiber;
a detector configured to detect an environmental state around the optical fiber from the backscattered light; and
an identifier configured to identify hanging down of the optical fiber from a detection result of the detector.

2. The identification system according to claim 1, wherein the environmental state is a vibration.

3. The identification system according to claim 1, wherein the environmental state is a temperature.

4. The identification system according to claim 1, wherein the detector detects at least one of (i) a time fluctuation in a certain position on the optical fiber and (ii) a spatial distribution on the optical fiber at a certain point in time, of the environmental state.

5. The identification system according to claim 1, wherein the detector detects the environmental state in time series basis at a plurality of positions on the optical fiber.

6. The identification system according to claim 1, wherein the identifier identifies a position of the hanging down of the optical fiber.

7. The identification system according to claim 1, wherein the optical fiber is a left fiber.

8. The identification system according to claim 1, wherein the hanging down of the optical fiber is hanging down of a drawn portion from an aerial wire into a house.

9. The identification system according to claim 1, wherein
the optical fiber is split into a plurality of branch fibers by an optical splitter, and
the identifier identifies, from a use situation of each branch fiber, a candidate of a branch fiber in which hanging down occurs.

10. The identification system according to claim 1, wherein the identifier identifies hanging down of the optical fiber by using a learning model of learning a relationship between the environmental state being detected by the detector and the hanging down of the optical fiber.

11. An identification device comprising:
an acquisition circuit configured to acquire information indicating backscattered light of pulse light being received from an optical fiber to which the pulse light is transmitted;
a detector configured to detect an environmental state around the optical fiber from information indicating the backscattered light; and
an identifier configured to identify hanging down of the optical fiber from a detection result of the detector.

12. An identification method comprising:
transmitting pulse light via an optical fiber;
receiving backscattered light of the pulse light from the optical fiber;
detecting an environmental state around the optical fiber from the backscattered light; and
identifying hanging down of the optical fiber from a result of the detection.

13. The identification system according to claim 2, wherein the detector detects at least one of (i) a time fluctuation in a certain position on the optical fiber and (ii) a spatial distribution on the optical fiber at a certain point in time, of the environmental state.

14. The identification system according to claim 3, wherein the detector detects at least one of (i) a time fluctuation in a certain position on the optical fiber and (ii) a spatial distribution on the optical fiber at a certain point in time, of the environmental state.

15. The identification system according to claim 2, wherein the detector detects the environmental state in time series basis at a plurality of positions on the optical fiber.

16. The identification system according to claim 3, wherein the detector detects the environmental state in time series basis at a plurality of positions on the optical fiber.

17. The identification system according to claim 4, wherein the detector detects the environmental state in time series basis at a plurality of positions on the optical fiber.

18. The identification system according to claim 2, wherein the identifier identifies a position of the hanging down of the optical fiber.

19. The identification system according to claim 3, wherein the identifier identifies a position of the hanging down of the optical fiber.

20. The identification system according to claim 4, wherein the identifier identifies a position of the hanging down of the optical fiber.
